(19) United States
(12) Patent Application Publication
(10) Pub. No.: US 2024/0291374 A1
(43) Pub. Date: Aug. 29, 2024

(54) METHOD TO SUPPRESS SWITCHING TRANSITION VOLTAGE OSCILLATION IN POWER ELECTRONICS CIRCUITS BY TURN-OFF OR TURN-ON CURRENT ZERO PLACEMENT

(71) Applicant: UT-Battelle, LLC, Oak Ridge, TN (US)

(72) Inventors: Veda Prakash Galigekere Nagabhushana, Knoxville, TN (US); Jason L. Pries, Oak Ridge, TN (US); Emre Gurpinar, Knoxville, TN (US); Md Shajjad Chowdhury, Knoxville, TN (US)

(21) Appl. No.: 18/588,785

(22) Filed: Feb. 27, 2024

Related U.S. Application Data
(60) Provisional application No. 63/448,461, filed on Feb. 27, 2023.

(51) Int. Cl. H02M 1/00; B60L 53/122; B60L 53/22; H02J 50/10; H02M 1/44; H02M 7/537

(52) U.S. Cl. CPC H02M 1/0054; B60L 53/122; B60L 53/22; H02J 50/10; H02M 1/44; H02M 7/537; B60L 2210/40

(57) ABSTRACT

An inverter circuit is provided to substantially mitigate parasitic ringing and to enable fast switching under high power conditions.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF INVENTION

The present disclosure relates to the field of inverter circuitry, and more particularly to mitigating parasitic resonance in inverter circuitry.

### BACKGROUND

Voltage oscillation or ringing caused by parasitic resonance during switching transitions inverter circuits is a limiting factor to achieve faster switching speeds. In addition to limiting the switching speed, parasitic ringing generates noise and electromagnetic interference (EMI) and leads to additional design challenges and complexity. The output capacitance of a MOSFET is charged during turn-off transition, and discharged during the turn-on transition. During the switching transient, the output capacitance can form a resonance with the parasitic inductance in the commutation loop. In a conventional half-bridge configuration, there are multiple contributors to parasitic inductance in a switching leg commutation loop such as power module leads, traces, and interconnects (e.g., wire bond), DC link capacitor terminations, and the PCB or busbar that provides to connection between MOSFETs and DC link capacitors.

### SUMMARY

In general, one innovative aspect of the subject matter described herein can be embodied in a inverter circuitry. The inverter circuitry may include a half bridge with a first MOSFET switch and a second MOSFET switch. The first MOSFET switch's drain may be coupled to a high voltage port of a DC power source, and the first MOSFET switch's source may be coupled to the second MOSFET switch's drain. The second MOSFET switch's source may be coupled to a low voltage port of the DC power source. The second MOSFET switch may be associated with a switching-transition network including a frequency-dependent input impedance zᵢₙ(f). The input impedance may include a maximum value zₘₐₓ(f₀) at a resonant frequency f₀. The switching transition network may have a switching transition occurring over duration ΔT.

In one embodiment, the second MOSFET switch's drain-source current I_{DS}(s=j2πf) is frequency dependent and has a value of zero at the inverse of the switching-transition duration,

$${I}_{D S} ( \frac{1}{Δ T} ) = 0 .$$

The switching-transition duration may be configured as the inverse of the input impedance's resonant frequency,

$$Δ T = \frac{1}{{f}_{0}} ,$$

to reduce overshot and/or parasitic ringing of the second MOSFET switch's drain-source voltage

$${V}_{DS} ( s ) = ( {I}_{DS} ( s ) {z}_{in} ( s ) ) {\vert}_{{f}_{0} = \frac{1}{Δ T}} .$$

The foregoing and other embodiments can each optionally include one or more of the following features, alone or in combination. In particular, one embodiment includes all the following features in combination.

In some embodiments, active components of the inverter circuitry and passive components of the inverter circuitry are preconfigured to cause the switching-transition duration to match the inverse of the resonant frequency,

$$Δ T = \frac{1}{{f}_{0}} .$$

In some embodiments, the inverter circuitry may include a sensor circuit arranged and configured to sense ringing of the second MOSFET switch's drain-source voltage V_{DS}(t). The inverter circuitry may be configured to determine a ringing frequency f₀ of the sensed drain-source voltage's ringing.

In some embodiments, the inverter circuitry may include a driver circuit configured to reset the second MOSFET switch's switching-transition duration to the determined inverse of the ringing frequency,

$$Δ T = \frac{1}{{f}_{0}} ,$$

and to drive the second MOSFET switch in accordance with the reset switching-transition duration.

In some embodiments, the switching transition is a turn-off switching transition of the drain-source current I_{DS}(s) from a specified value ΔI to zero over the duration ΔT.

In some embodiments, the first MOSFET switch and the second MOSFET switch each is a SiC MOSFET.

In some embodiments, a wireless power transfer system for wirelessly providing AC power to an electric vehicle or a plug-in electric vehicle is provided. The system may include a DC power source and an instance of inverter circuitry according to one or more embodiments described herein.

In general, one innovative aspect of the subject matter described herein can be embodied in an inverter operable to generate AC power. The inverter may include an input operable to receive input power, and switching circuitry operably coupled to the input the switching circuitry. The switching circuitry may be operable to generate the AC power based on the input power, and to turn on and turn off to generate the AC power. The switching circuitry may include a parasitic resonance in response to the turn off of the switching circuitry. The switching circuitry may be configured to turn off according to a turn off time that has a frequency response with a zero substantially corresponding to a parasitic resonant frequency f₀ of the parasitic resonance of the switching circuitry. The inverter may include an output operable to supply the AC power generated by the switching circuitry.

The foregoing and other embodiments can each optionally include one or more of the following features, alone or in combination. In particular, one embodiment includes all the following features in combination.

In some embodiments, the switching circuitry may include a first switch including a first switch upper node, a first switch lower node, and a first switch control node operable to control current flow between the first switch upper node and the first switch lower node. The switching circuitry may include a second switch including a second switch upper node, a second switch lower node, and a second switch control node operable to control current flow between the second switch upper node and the second switch lower node. The turn off of the switching circuitry may correspond to controlling the second switch control node to substantially turn off the current flow between the second switch upper node and the second switch lower node. An impedance of the second switch may be associated with a frequency response during the turn off that defines the parasitic resonance of the switching circuitry over the turn off time.

In some embodiments, the first switch is a first MOSFET, the first switch lower node is a first switch source, the first switch upper node is a first switch drain. The second switch is a second MOSFET, the second switch lower node is a second switch source, and the second switch upper node is a second switch drain.

In some embodiments, the first switch upper node may be coupled to a high voltage port of the input, and the second switch lower node may be coupled to a low voltage port of the input. The first switch lower node may be operably coupled to the second switch upper node, and the first switch lower node and the second switch upper node may be operably coupled to the output.

In some embodiments, the second switch may be associated with a switching-transition network including the impedance, where the impedance of the switching-transition network is a frequency-dependent input impedance zᵢₙ(f). The impedance may include a maximum value zₘₐₓ(f₀) at the parasitic resonant frequency f₀, and the switching-transition network may have a switching transition occurring over duration ΔT defined by the turn off time.

In some embodiments, the current between the second switch upper node and the second switch lower node may be frequency dependent according to the frequency response and the zero of the frequency response is at an inverse of duration ΔT. The duration ΔT may be configured as the inverse of the parasitic resonant frequency,

$$Δ T = \frac{1}{{f}_{0}} ,$$

to reduce overshoot and/or parasitic ringing of a voltage across the second switch upper node and the second switch lower node.

In some embodiments, the switching transition may be a turn-off switching transition of the current between the second switch upper node and the second switch lower node from a specified value to zero over the duration ΔT.

In some embodiments, active components of the inverter and passive components of the inverter may be preconfigured to cause the turn off time to match an inverse of the parasitic resonant frequency 1/f₀.

In some embodiments, a sensor circuit may be configured to sense ringing of a voltage across the second switch, and to determine a ringing frequency of the sensed ringing as the parasitic resonant frequency. A driver circuit may be configured to adjust the turn off duration to an inverse of the ringing frequency, and to drive the second switch in accordance with the adjusted turn off duration.

In some embodiments, a wireless power supply for wireless transmitting AC power to a remote device is provided. The wireless power supply may include an inverter according to one or more embodiments described herein. The wireless power supply may include a transmitter operably coupled to the output of the inverter, with the transmitter being operable to provide wireless power to the remote device based on AC power received from the output of the inverter.

In some embodiments, the wireless power supply may include a driver circuit operable to direct operation of the inverter circuit.

In some embodiments, the driver circuit may be configured to adjust the turn off time to reduce ringing at the parasitic resonant frequency.

In some embodiments, the wireless power supply may include sensor circuitry operable to detect a change in the parasitic resonant frequency f₀.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components. Any reference to claim elements as “at least one of X, Y and Z” is meant to include any one of X, Y or Z individually, and any combination of X, Y and Z, for example, X, Y, Z; X, Y; X, Z; and Y, Z.

### BRIEF DESCRIPTION OF THE DRAWINGS

FIG. 1 shows inverter circuitry according to one embodiment incorporated in a wireless power system.

FIG. 2 shows inverter circuitry according to one embodiment.

FIG. 3 shows a double pulse setup for switching circuitry according to one embodiment.

FIG. 4 shows a small signal setup for switching circuitry according to one embodiment.

FIG. 5 shows a frequency domain analysis of inverter circuitry according to one embodiment.

FIG. 6A shows a turn off current waveform for inverter circuitry according to one embodiment.

FIG. 6B shows decomposition of the turn off current waveform of FIG. 6A for analysis using a Laplace transform according to one embodiment.

FIG. 7 shows magnitude of the switch drain to source current during turn off with one slope transition according to one embodiment.

FIG. 8 shows a turn off current waveform according to one embodiment.

FIG. 9 shows decomposition of the turn off current waveform of FIG. 8 for analysis using a Laplace transform according to one embodiment.

FIG. 10 shows spectra for operation of inverter circuitry according to one embodiment.

FIG. 11 shows ringing and mitigation of the same for inverter circuitry according to one embodiment.

FIG. 12 shows ringing and mitigation of the same for inverter circuitry according to one embodiment.

### DESCRIPTION

The present disclosure is directed to an inverter circuit configured to substantially mitigate parasitic ringing to enable fast switching under high power conditions.

As described herein, voltage oscillation or ringing caused by parasitic resonance during switching transitions is a limiting factor to achieve faster switching speeds, which is useful to realize the full performance benefits of modern wide bandgap semiconductors, particularly in hard-switched voltage source topologies. In addition to limiting the switching speed, parasitic ringing generates noise and electromagnetic interference (EMI) and leads to additional design challenges and complexity. The output capacitance of a MOSFET is charged during turn-off transition, and discharged during the turn-on transition. During the switching transient, the output capacitance can form a resonance with the parasitic inductance in the commutation loop. In a conventional half-bridge configuration, there are multiple contributors to parasitic inductance in a switching leg commutation loop such as power module leads, traces, and interconnects (e.g., wire bond), DC link capacitor terminations, and the PCB or busbar that provides connection between MOSFETs and DC Link capacitors.

In case of isolated power converters such as flyback converters, the leakage inductance of the transformer or coupled inductors can also contribute to the parasitic inductance in the commutation loop. Hard-switched power converters, including all basic switched mode power converters (SMPC) such as Buck (and Buck derived topologies including half-bridge and full-bridge converters), Boost (and numerous Boost derived topologies), and Buck-boost (and Buck-boost derived topologies including the popular Flyback converter) converters. Methods for mitigating the switching-transition voltage oscillations, which do not include considerably slowing down the device switching speed, may include one or more of the following:

1) Adding a snubber network—this conventional technique is often used for low power applications such as a Flyback converter-based power supply where the turn-off voltage overshoot can be significant and detrimental for every turn-off transition. In high power, high switching frequency applications (e.g., traction drive inverters), snubber elements may dissipate large amounts of energy in a short period of time, exasperating thermal and enhanced safety challenges. However, in high power, low switching frequency applications such as HVDC systems, snubbers may be used to divert the switching losses from the devices, such as IGCTs, to the snubber circuit and provide safe operation for the system.

2) Active gate driving techniques—the switching speed of the MOSFET may be adjusted during the transition period to enhance or optimize the waveform for power loss, EMI, and voltage overshoot by controlling the gate-source voltage. Closed loop control schemes for di/dt and dV/dt control of a high power S₁ IGBT module may be utilized. Current and voltage slopes can be adjusted independent of IGBT nonlinearities or parameter variations, including configurations when the module includes S₁ IGBT and S₁ diode combinations. However, the switching results with SiC Schottky diodes may exhibit high frequency oscillation during turn-off, making it uncertain if the closed loop control system can dampen the voltage oscillation during turn-off or not.

An open-loop active gate driver based on adjusting dynamic gate resistance of a GaN HEMT during switching transitions to combat overshoot, oscillation, and EMI may be utilized. The programmable gate driver may be implemented on a bespoke silicon integrated circuit.

3) Commutation loop optimization—this method may include mitigating ringing voltage overshoot and oscillation for high power applications. The approach may involve the estimating and minimizing of parasitic loop inductance by sizing the DC-link capacitance, capacitor placement and extensive numerical modeling and analysis of various bus bar geometries. For instance, bus bar and capacitor placement for a high power SiC MOSFET-based three phase inverter may be provided to mitigate ringing voltage overshoot. This approach, however, may provide limited impact on high frequency oscillation and voltage overshoot during turn-off.

In one embodiment according to the present disclosure, a comprehensive frequency domain analysis of the switching-transition (turn-off) parasitic ringing phenomenon may be provided including the effect of decoupling capacitor.

Analysis, characterization, and mitigation of switching transition parasitic ringing is provided herein. To facilitate discussion, a simple circuit model including the MOSFET turn-off speed, current amplitude, MOSFET output capacitance COSS, is provided along with time domain circuit analysis to develop a closed-form expression for MOSFET turn-off over voltage. The trade-offs between switching loss and signal oscillation may be considered via time domain circuit analysis as well as through analysis of a more detailed circuit model including the common source and switching-loop inductances. Evaluating the effect of stray inductance on MOSFET switching characteristics, and optimal placement and design of the decoupling capacitor from packaging perspectives may be considered. A graphical method to predict asymptotic envelopes for EMI spectra of trapezoidal signals may also be considered.

Analysis of switching transition voltage oscillation may be conducted via time domain analysis and circuit models. Parasitic ringing phenomenon may pertain to at least a second order LC network with multiple resonant modes and is excited by an aperiodic non-sinusoidal current source. The small-signal terminal impedance of the turn-off parasitic ringing network in frequency domain can be analyzed to facilitate identifying decoupling the higher inductance path from the device terminals using Bode plots (input impedance plots). Although the derived small-signal model and frequency domain analysis is helpful in predicting the frequency dependent input impedance and resonant modes of the switching-transition equivalent network, the frequency components of the switching transition current (turn-off) may be uncaptured, which is the excitation for the switching-transition network, and its effect on the overall response. Time-domain or frequency domain analysis of switching-transition ringing may be provided to analyze turn-off current with two distinct slopes as seen in WBG MOSFETs under certain conditions.

In one embodiment of the present disclosure, a method is provided to decompose the single slope and two slope MOSFET turn-off currents into base signals and obtain the frequency dependent current magnitude using Laplace transformation. Frequency dependent input impedance and resonant modes of the switching-transition (turn-off) equivalent network may be provided. A method to predict the parasitic voltage oscillation as a function of the MOSFET turn-off current and input impedance may also be provided.

### I. Overview

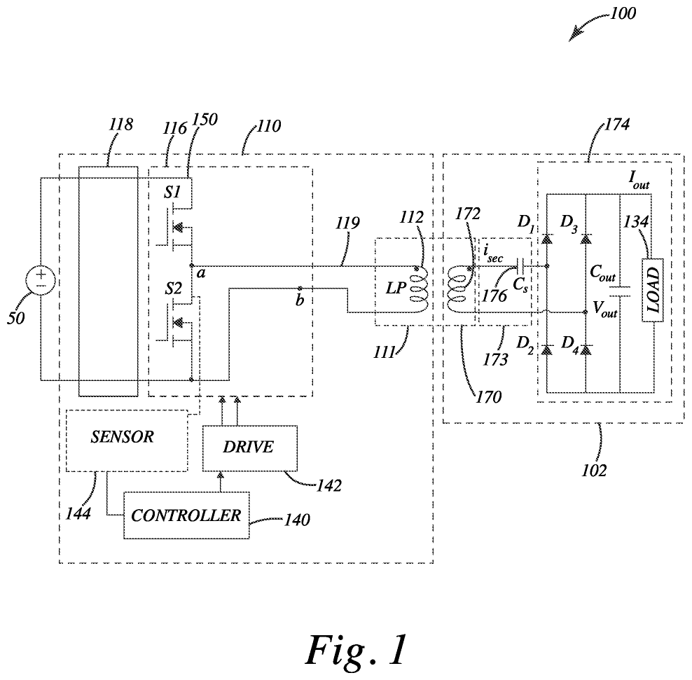

A wireless power system in accordance with one embodiment is shown in FIG. 1 and generally designated 100. The wireless power system 100 may include switching circuitry or inverter circuitry according to one or more embodiments described herein. It is noted, however, that the switching circuitry or inverter circuitry is not limited to wireless power systems and may be provided in any type of application.

The wireless power system 100 in the illustrated embodiment includes a remote device 102 and a wireless power supply 110 configured to transmit wireless power to the remote device 102. The remote device 102 may be described as a secondary-side, vehicle-side, or receiver-side with respect to the wireless power supply 110. In one embodiment, the remote device 102 may be operable to transmit power to the wireless power supply 110 (if the diodes in 102 are replaced with active switches [e.g., an inverter circuit according to one embodiment described herein]), which may be configured to receive wireless power in addition to or as an alternative to transmitting wireless power to the remote device 102. The remote device 102 or one or more components thereof may be incorporated into any type of apparatus or device, including, for instance, a vehicle, a mobile phone, a table top appliance, a laptop, a tablet, or a power tool charger or any type of isolated power supply configuration for wireless power with resident converters may be configured in accordance with one or more embodiments described herein.

Additional examples of applications include a vehicle provided as an electric vehicle, a plug-in hybrid electric vehicle, or an electric/plug-in hybrid combat vehicle. Further example applications can relate to energy storage provided in a variety of forms, including a stationary or mobile energy storage system, a low/high voltage battery charger being a cell phone, a laptop, a tablet, a power tool, a gardening tool, a handheld vacuum cleaner, a kitchen gadget, any type of battery charger or adapter, chargers for portable electronics (including cameras, laptops, and cell phones), house-hold appliances with grid isolation requirements, air mobility vehicles (such as electric/hybrid propulsion aircraft, drones, UAVs, and satellites), laser or plasma applications, LEDs, single-phase or three-phase grid systems with medium or low grid voltage networks, fuel cell, solar, or wind turbine renewable energy conversion systems, microturbines (e.g., in grid connected applications), and High Voltage (HV) systems.

The remote device 102 in the illustrated embodiment includes a load 134, such as a battery, operable to use power received wirelessly from the wireless power supply 110. For instance, the wireless power receiver 170 may be coupled to a load 134 to provide power thereto. The load 134 in the illustrated embodiment is part of or coupled to receiver-side circuitry 174 (or secondary-side circuitry) operable to receive power from the wireless power receiver 170. The load 134 may include a battery (or a battery and a battery management system [BMS]) or any type of principle load, or a combination thereof. The wireless power receiver 170 in the illustrated embodiment includes a receiver 172 (e.g., a secondary coil or a pick-up coil). The remote device 102 may include a secondary series compensation circuit 173, including a capacitor Cs, 176.

In the illustrated embodiment of FIG. 1, the wireless power supply 110 may include a wireless power transmitter 111 having a transmitter 112 (e.g., a primary coil) operable to couple with the receiver 172 for wirelessly transferring power, such as by magnetic coupling or inductive coupling. As described herein, the transmitter 112 and the receiver 172 may vary depending on the application, and are not limited to a single primary coil or a single secondary coil. For instance, a three-phase system with three separately driven coils may be provided, with a three coil system being provided at the receiver-side as well.

The wireless power supply 110 may be operable to receive power from a source 50, which may be a DC source. Alternatively, the source 50 may be an AC source, and the wireless power supply 110 may receive power from an AC grid connection. In this configuration, a grid interface converter, such as an AC/DC rectifier may be used to supply power to switching circuitry 116 (e.g., an inverter) as described herein. In one embodiment, the AC source before such an AC/DC rectifier may be provided via grid power or utility power, and may be single phase or three-phase depending on the application as described herein.

The wireless power supply 110 in the illustrated embodiment includes a controller 140 operably coupled to drive circuitry 142. The drive circuitry 142 may include a multiplexor or signal conditioning circuitry, or both, in the form of a gate driver interface to translate output from the controller 140 to direct operation of the switching circuitry 116. Alternatively, the drive circuitry 142 may correspond to pass through conductors that provide a direct connection between switching circuitry 116 and the controller 140.

The wireless power supply 110 may optionally include a sensor 144. The sensor 144 may be configured to detect a characteristic of power of the wireless power supply 110, such as a characteristic of power in the switching circuitry 116. The characteristic of power may pertain to a voltage or current measured or determined with respect to the second switch S2. For instance, in the illustrated embodiment, the sensor 144 is operable sense ringing of voltage across the second switch S2 and to generate a signal indicative of the ringing of voltage. The output from the sensor 144 may be digital or analog and indicative of the detected characteristic of power. This output from the sensor 144 may be provided to the controller 140. The sensor 144 is shown separate from the controller 140, but may be integral therewith in one embodiment. The sensor 144 is not limited to the configuration described and shown in conjunction with FIG. 1—for instance, the sensor 144 may sense a characteristic of power in a portion of the wireless power supply 110.

The switching circuitry 116 in the illustrated embodiment includes a half-bridge inverter configuration with first and second switches S1, S2 capable of operating in conjunction with each other to supply power to the transmitter 112. The switching circuitry 116 may also be configured in a full-bridge configuration with additional switches similar to switches S1, S2 arranged with node b being between the additional switches. Additionally, or alternatively, the switching circuitry 116 may be configured as a three-phase inverter with the additional sets of switches.

The switches S1, S2 in the illustrated embodiment are configured MOSFETs each with a source, a drain, and a gate. The gates of the switches S1, S2 may be coupled to the drive circuitry 142 and operable in response to one or more signals from the drive circuitry 142. In the illustrated embodiment, the source of each of the switches S1, S2 may correspond to a lower node of the respective switch S1, S2, and the drain of each of the switches S1, S2 may correspond to an upper node of the respective switch S1, S2. Control over the gate of the switches S1, S2 may enable and disable current flow between the upper and lower nodes (e.g., between the drain and source) of the respective switches S1, S2, thereby controlling voltage and current with respect to an output node 119 (node a) between the lower node of switch S1 and the upper node of switch S2 relative to a reference node (node b).

The switching circuitry 116 may be configured to receive input power 150 from the power supply 50, and to generate AC power to be supplied to the transmitter 112. The controller 140 may direct operation of the switching circuitry 116 according to a switching frequency and duty cycle (pulse width) to generate the high-frequency AC power. The switching frequency may be between 3 kHz and 10 MHz, and may optionally be about 85 kHz. In one embodiment, the controller 140 may be operable to vary a switching frequency of the switching circuitry 116. As an example, the controller 140 may obtain sensor feedback from the sensor 144, and adjust the switching frequency or the duty cycle (e.g., pulse width) based on the sensor feedback.

The switches S1, S2 may be MOSFETs or any other type of switch capable of selectively supplying power to the transmitter 112, including for example IGBTs.

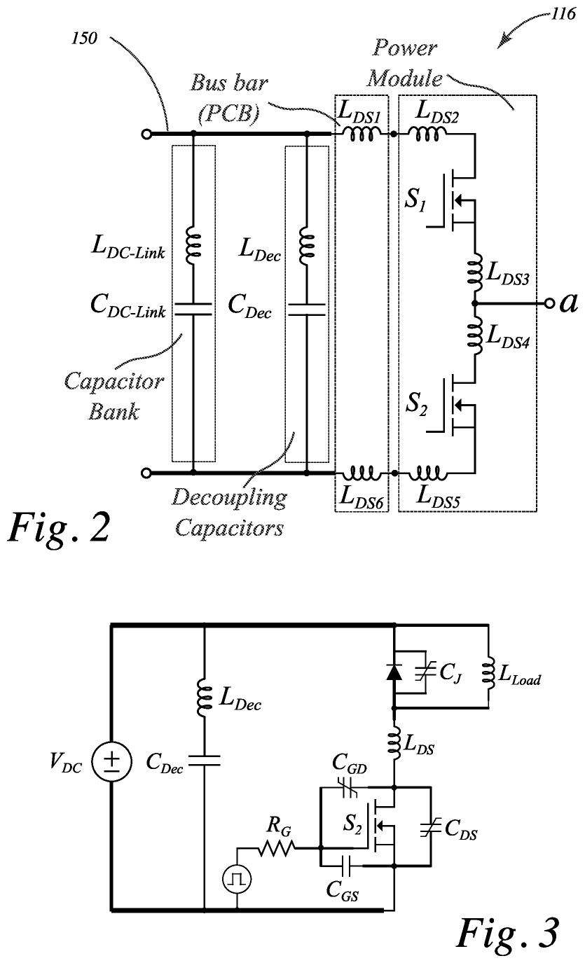

The switching circuitry 116 is shown in further detail in FIG. 2 along with DC link capacitance C_{DC-Link} and decoupling capacitance C_{Dec}, along with parasitic inductances L_{DC-Link}, L_{Dec}, L_{DS1}, L_{DS2}, L_{DS3}, L_{DS4}, L_{DS5}, L_{DS6} shown for purposes of discussion and analysis.

In the illustrated embodiment, the wireless power supply 110 includes power conditioning circuitry 118 capable of conditioning the power received from the power source 50. The power conditioning circuitry 118 in the illustrated embodiment corresponds to a pass-through configuration between the power supply 50 and the switching circuitry 116. However, the present disclosure is not so limited. As an example, the power conditioning circuitry 118 may correspond to rectification circuitry operable to rectify AC power received from an AC power source into DC power as the input power 150 provided to the switching circuitry 116. Additionally, or alternatively, the power conditioning circuitry may include filter or compensation circuitry, such as a choke inductor, a parallel capacitor, or a combination of an inductor and capacitor to form a filter at the point of grid connection. If the power conditioning circuitry 118 is utilized for a grid interface, then the source 50 may be a single or three-phase AC source. If a grid interface is not used or bypassed, then the source 50 is a DC source.

The controller 140 may be coupled to one or more components of the wireless power systems to achieve operation in accordance with the described functionality and methodology.

The controller 140 may include electrical circuitry and components to carry out the functions and algorithms described herein. Generally speaking, the controller 140 may include one or more microcontrollers, microprocessors, digital signal processors (DSP), and/or other programmable electronics that are programmed to carry out the functions described herein. The controller 140 may additionally or alternatively include other electronic components that are programmed to carry out the functions described herein, or that support the microcontrollers, microprocessors, and/or other electronics. The other electronic components include, but are not limited to, one or more field programmable gate arrays (FPGAs), systems on a chip, volatile or nonvolatile memory, discrete circuitry, integrated circuits, application specific integrated circuits (ASICs) and/or other hardware, software, or firmware. Such components can be physically configured in any suitable manner, such as by mounting them to one or more circuit boards, or arranging them in other manners, whether combined into a single unit or distributed across multiple units. Such components may be physically distributed in different positions in the system or aspects thereof, or they may reside in a common location within the system or an aspect thereof. When physically distributed, the components may communicate using any suitable serial or parallel communication protocol, such as, but not limited to, CAN, LIN, Vehicle Area Network (VAN), FireWire, I2C, RS-232, RS-485, Ethernet, LAN, WiFi, and Universal Serial Bus (USB).

The wireless power system 100, in the illustrated embodiment, is configured to receive power from the source 50 in the form of an AC power source, and includes power conditioning circuitry 118 configured to rectify the AC power received from the source 50 into DC power for the switching circuitry 116. By selective control of the switching circuitry 116, power may be supplied to the transmitter 112 in order to transfer power wirelessly to the receiver 172.

Power transmitted wirelessly from the transmitter 112 to the receiver 172 may be provided to receiver-side circuitry 174, which may rectify AC power output from the receiver 172 into DC power supplied to the load 134 (e.g., a battery).

For a wireless power system 100 in accordance with one embodiment, the primary coil, also described as a transmitter coil or the transmitter 112 or transmitter inductance, may vary from application to application depending on construction, a primary coil current, or a power level, or a combination thereof.

### II. Inverter Circuitry Configuration and Analysis

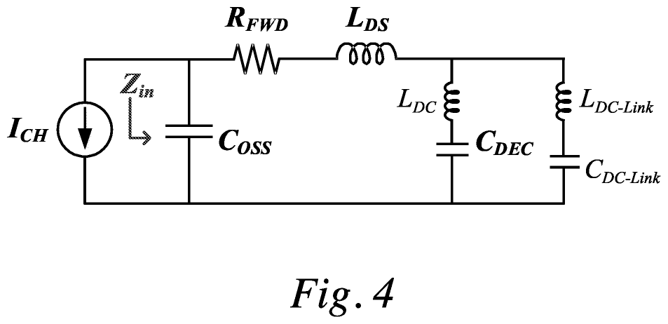

In the illustrated embodiment of FIG. 3, a double-pulse setup is provided to study the switching behavior of power switching devices S₁, S₂, such switches in the form of MOSFETs. In FIG. 3, switches S₁ and S₂ form a phase-leg module, and switch S₂ is the device under study. Switches S₁ and S₂ each have an output capacitance Cₒₛₛ and an anti-parallel Diode with a forward voltage drop of V_{Fw D} and forward resistance of R_{FW D}, respectively. L_{DS} is the lumped commutation loop parasitic inductance, C_{Dec} and L_{Dec} are the effective capacitance and equivalent series inductance (ESL) of the decoupling capacitor, and C_{DC-Link} and L_{DC-Link} are the effective capacitance and ESL of the DC link capacitor, respectively. Although both the turn-on and the turn-off transitions are affected by parasitic ringing, for purposes of discussion, the analysis herein focuses primarily on the turn-off transition. However, it is to be understood that the disclosed methodology is applicable to analyzing and adjusting the inverter configuration to mitigate the turn-on transition ringing as well. A small-signal model of the double-pulse setup shown in FIG. 4 is derived based on and shown in FIG. 3. In FIG. 4, the current source is modeled on the switch S1 turn-off current and is feeding the frequency dependent network with input impedance Zin. The frequency domain analysis of the current source is described herein. From FIG. 4, the frequency dependent input impedance of the turn-off transition equivalent circuit including the decoupling capacitor can be determined as follows:

$${Z}_{in} ( s ) = \{ [ ( {Z}_{{C}_{DC - Link}} + {Z}_{{L}_{DC - Link}} ) ‖ ( {Z}_{{C}_{Dec}} + {Z}_{{L}_{Dec}} ) ] + ( {Z}_{{L}_{DS}} + {R}_{FWD} ) \} ‖ {Z}_{{C}_{OSS}} . \qquad ( 1 )$$

The input impedance without the decoupling capacitor C_{Dec} may also be considered to highlight the effect of decoupling capacitor and is given as follows:

$${Z}_{i n - alt} ( s ) = \{ ( {Z}_{{C}_{D C - Link}} + {Z}_{{L}_{D C - Link}} ) + ( {Z}_{{L}_{DS}} + {R}_{FWD} ) \} ‖ {Z}_{{C}_{OSS}} . \qquad ( 2 )$$

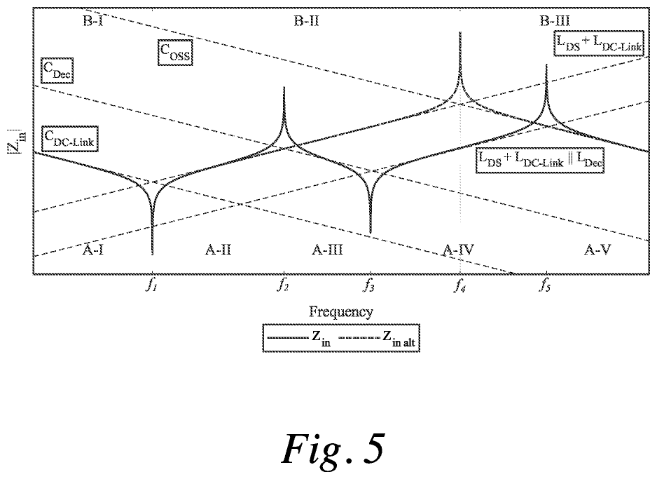

The idealized input impedances, with and without the decoupling capacitor given by equations (1) and (2), respectively, and are plotted in FIG. 5. When C_{DC-Link}>C_{Dec}>Cₒₛₛ, the input impedance Zᵢₙ of switching transition equivalent circuit shown in FIG. 4 has three capacitive regions (A-I, A-III, and A-V), two inductive regions (A-II and A-IV), and four resonant frequencies (f1,2, . . . 4). The input impedance Zᵢₙ₋ₐₗₜ of the switching transition equivalent circuit without the decoupling capacitor has two capacitive regions (B-I and B-III) and one wide-band inductive region (B-II) as shown in the idealized impedance plot in FIG. 5. The five characteristic regions of the input impedance with the decoupling capacitor Zᵢₙ are as follows:

A-I (0≤f≤f₁): In the low frequency region, the input impedance Zᵢₙ is dominated by the impedance of the DC link capacitor C_{DC-Link}, and it asymptotically reaches infinity for DC. As the frequency increases, the input impedance Zᵢₙ decreases linearly until the parasitic inductive impedance of the module and the DC link capacitor L_{DS}+L_{DC-Link} forms a series resonant point with the DC link capacitor C_{DC_Link}. The corresponding resonant frequency is given by equation 3. Beyond the frequency f₁, the impedance of DC link capacitor does not play a significant role.

A-II (f₁≤f≤f₂): In this region the input impedance Zᵢₙ is dominated by the parasitic inductances of the module and the DC link capacitor L_{DS} and L_{DC-Link}. This inductive impedance increases linearly with frequency until it resonates with the decoupling capacitance C_{Dec} at the resonant frequency f₂, given by equation 4.

A-III (f₂≤f≤f₃): In this region, the increasing parasitic inductive impedance of the module and the DC link capacitor L_{DS}+L_{DC-Link} is mitigated by the lower impedance path offered by the decoupling capacitor C_{Dec}. It can be seen in FIG. 5 that the input impedance without the decoupling capacitance Z_{in_alt} continues to increase while the input impedance with the decoupling capacitor C_{Dec} decreases as a function of frequency until f₃. At f₃, inductive impedance L_{DS}+L_{Dec}∥L_{Dc-Link} equalizes the capacitive impedance C_{Dec} to form a resonant point f₃ given by equation 5. The decoupling capacitor C_{Dec} value may be selected to have sufficient separation between f₂ and f₃, this ensures decoupling of the inductive impedance, to the extent possible, from resonating with the device output capacitance, which is Cₒₛₛ in case of a switch in the form of a MOSFET.

A-IV (f₃≤f≤f₄): Beyond f₃, the input impedance is dictated by the inductive impedance combination of the module, decoupling capacitor and the DC link capacitor L_{DS}+L_{Dec}∥L_{DC-Link}. The inductive impedance increases linearly with frequency until it resonates with the impedance offered by the device output capacitance Cₒₛₛ at f₄. The resonant frequency f₄ is given by equation 6.

A-V (f≥f₄): For frequencies beyond f₄, the input impedance is dominated by the output capacitance Cₒₛₛ of the switch S2 (e.g., the MOSFET). From FIG. 4, it can be seen that Cₒₛₛ acts like a shunt by offering a low impedance path.

The four resonant frequencies of the turn-off transition equivalent circuit with decoupling capacitor C_{Dec} are provided as follows:

$$2 π {f}_{1} = \sqrt[- 2]{{C}_{D C - Link} \cdot ( {L}_{DS} + {L}_{D C - LINK} )} , \qquad ( 3 )$$

$$2 π {f}_{2} = \sqrt[- 2]{{C}_{Dec} \cdot ( {L}_{Dec} + {L}_{D C - LINK} )} , \qquad ( 4 )$$

$$2 π {f}_{3} = \sqrt[- 2]{{C}_{Dec} \cdot ( {L}_{Dec} + {L}_{D C - LINK} ‖ {L}_{DS} )} , \qquad ( 5 )$$

$$2 π {f}_{4} = \sqrt[- 2]{{C}_{oss} \cdot ( {L}_{DS} + {L}_{Dec} ‖ {L}_{D C - Link} )} , \qquad ( 6 )$$

The three characteristic regions of the input impedance without the decoupling capacitor Zᵢₙ₋ₐₗₜ may be defined as follows:

B-I (0≤f≤f₁): In the low frequency region the input impedance is dominated by the DC link capacitor C_{DC-Link}, and the characteristics are identical to region A-I including the resonant point f₁ between the parasitic inductive impedance of the module and the DC link capacitor L_{DS}+L_{DC-Link}.

B-II (f₁≤f≤f₂): In this region the input impedance Z_{in alt} is dominated by the parasitic inductive impedance of the module L_{DS} and the DC Link capacitor L_{DC-Link}. The impedance Z_{in_alt} increases linearly over a wide range of frequencies which encompasses the equivalent regions A-II, A-III, and A-IV partially. This leads to a significant increase in the impedance of Z_{in alt} as compared to Zᵢₙ, which has the effect of lowering the input impedance due to the presence of decoupling capacitor between f₂ and f₃. The input impedance Z_{in_alt} may increase until the inductive impedance L_{DS}+L_{DC-Link} resonates with the output capacitance of the switch S2 (e.g., a MOSFET), Cₒₛₛ at f₅ and given by equation 7.

B-III (f>f₅): For frequencies beyond f₅, the input impedance Z_{in_alt} is the impedance of the switch S2 output capacitance Cₒₛₛ.

The first resonant frequency of the turn-off transition equivalent circuit without a decoupling capacitor is the same as given by equation 3, and the second resonant frequency is provided as follows:

$$2 π {f}_{5} = \sqrt[- 2]{{C}_{OSS} \cdot ( {L}_{DS} + {L}_{D C - Link} )} . \qquad ( 7 )$$

It can be inferred from FIG. 5 that the resonance between the parasitic inductances and the output capacitance given by f₅ in the input impedance without decoupling capacitor Z_{in_alt} is split into multiple resonant frequencies f_{2,3, and 5} due to the addition of the decoupling capacitor C_{Dec} resulting in Zᵢₙ. The input impedance without decoupling capacitor Z_{in_alt} has one dominant resonant mode with a relatively higher input impedance magnitude (f₅) as compared to input impedance with decoupling capacitor Zᵢₙ which has two resonant modes with considerably lower input impedances (f₂ and f₄). When excited by a frequency rich current source, this leads to a lower amplitude voltage ringing which is a product of IOff(s) and Zin(s), as elaborated in II-B.

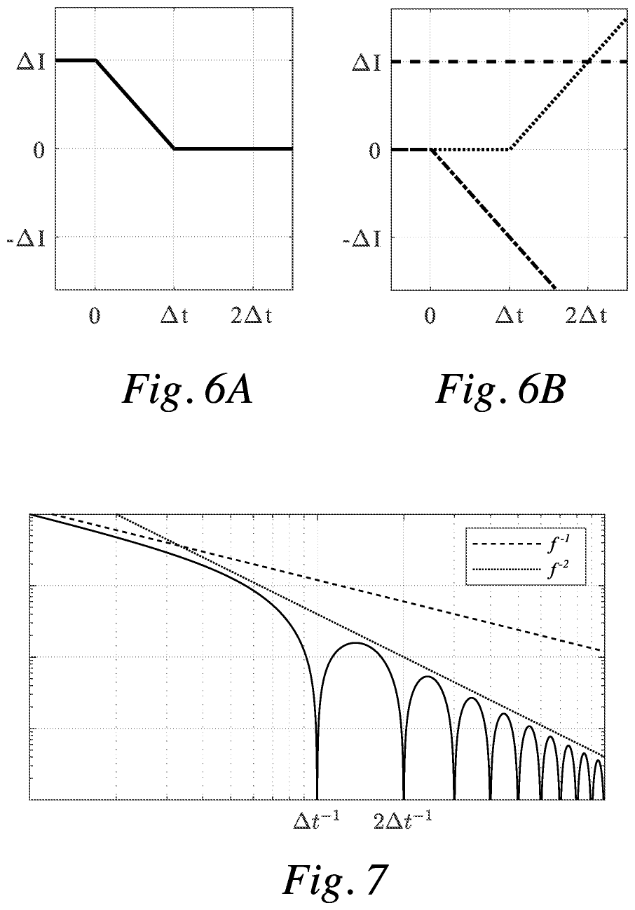

During inductive hard switching applications, the turn-off drain current of the switches S1, S2 (e.g., SiC MOSFETs) can have either one or two distinct slopes based on the operating region, the device parameters, and switching speed. The junction capacitance of the freewheeling diode, or the upper-switch S1 in a double pulse setup, can introduce charging current during change of voltage across the upper switch S1. The influence of junction capacitance charging current may be prominent for high current applications where the junction capacitance may increase with the device cross section, and high switching speed (dV/dt) conditions. In both cases, the time domain representation of the turn-off current can be decomposed based on a combination of constant valued and standard ramp functions. The nomenclature for single-slope switch turn-off current is I_{DS2} and for the two-slope switch current is I_{DS1}. The nomenclature is applicable to both frequency domain and time domain wave-forms and representation. The time domain representation of the single-slope switch turn-off current and the decomposition is shown in FIGS. 6A and 6B, respectively.

In FIG. 6B, the current falls linearly from a positive value ΔI to 0 in a finite time period ΔT. The turn-off current is decomposed into two standard ramp and a constant valued function as shown in FIG. 6B. This decomposition enables representing the time domain current in terms of Laplace transformation of standard continuous signals. The time domain expression for the switch drain-to-source current during the turn-off with a one-slope transition is provided as the following, where R(t) is the standard ramp function:

$${I}_{{DS}_{1}} ( t ) = Δ I - \frac{Δ I}{Δ T} R ( t ) + \frac{Δ I}{Δ T} R ( t - Δ T ) , \qquad ( 8 )$$

The Laplace transformation of equation 8 provides the frequency domain expression for the switch drain-to-source current during the turn-off with a one-slope transition as the following:

$${I}_{{DS}_{1}} ( s ) = Δ I δ ( s ) - \frac{Δ I}{Δ T} \frac{1}{{s}^{2}} + \frac{Δ I}{Δ T} \frac{1}{{s}^{2}} {e}^{- Δ T ( s )} . \qquad ( 9 )$$

The magnitude of equation 9 may be evaluated at s=j2πf to obtain the magnitude of switch drain-to-source current during the turn-off with a one-slope transition |I_{DS}_{₁}(s)|, and has the form as shown in FIG. 7. From FIG. 7, it can be seen that the magnitude of the |I_{DS}_{₁}(s)| decreases as a function of frequency but touches zero for integer multiples of current turn off frequency These frequency points can be postulated to be the ‘zeros’ of the turn off current. Control over the fall-time for the current provided to the switch S2 may be controls such that the current spectra transfer function has a zero at the resonant frequency (e.g., the parasitic resonant frequency) of the switch S2 to reduce, mitigate, or eliminate overshoot ringing.

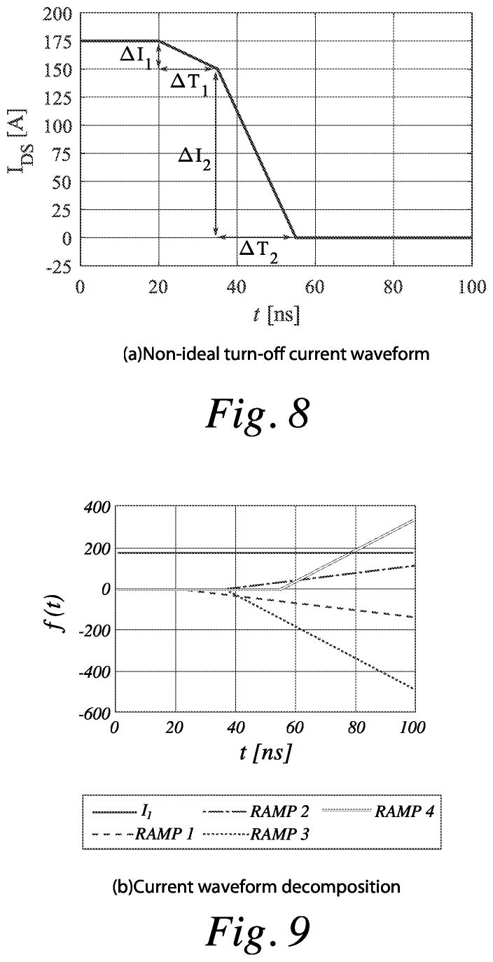

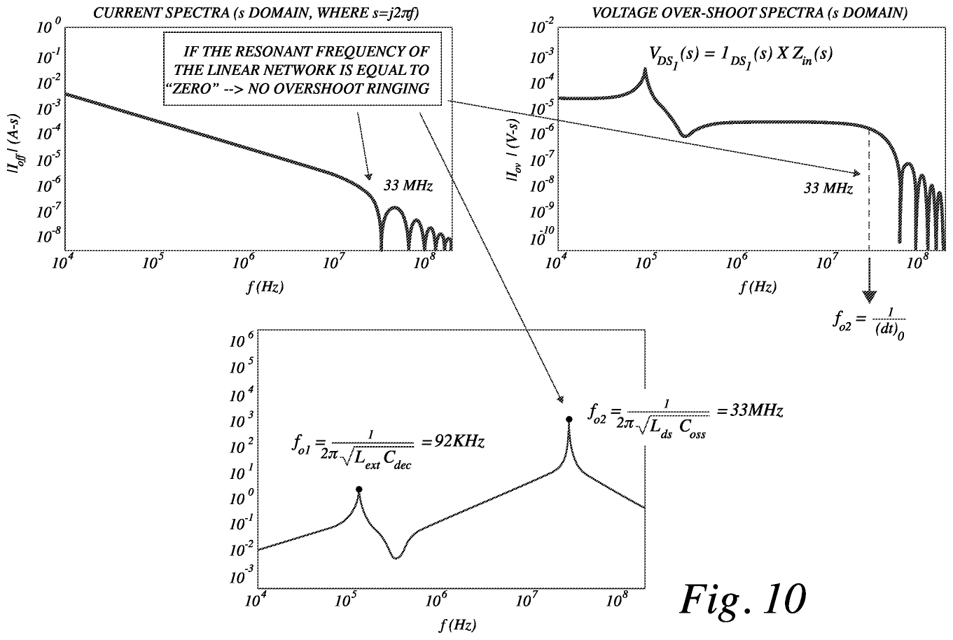

The switch drain-to-source current during turn-off with two-slope transition can be approximated by two straight lines with distinct slopes given by ΔI₁/ΔT₁ and ΔI₂/ΔT₂ as shown in FIG. 8. The two slope drain-to-source current can be decomposed based on standard constant valued and ramp functions as well as shown in FIG. 6B and provided according to the following:

$${I}_{{DS}_{2}} ( t ) = Δ {I}_{1} - {F}_{1} ( t ) + {F}_{2} ( t ) - {F}_{3} ( t ) + {F}_{4} ( t ) , \qquad ( 10 )$$

where F_{1, 2, 3, and 4} (t) are defined according to the following:

$${F}_{1} ( t ) = t \frac{Δ {I}_{1}}{Δ {T}_{1}} u ( t ) = \frac{Δ {I}_{1}}{Δ {T}_{1}} R ( t ) \qquad ( 11 )$$

$${F}_{2} ( t ) = ( t - Δ {T}_{1} ) \frac{Δ {I}_{1}}{Δ {T}_{1}} u ( t - Δ {T}_{1} ) = \frac{Δ {I}_{1}}{Δ {T}_{1}} R ( t - Δ {T}_{1} ) \qquad ( 12 )$$

$${F}_{23} ( t ) = ( t - Δ {T}_{1} ) \frac{Δ {I}_{2}}{Δ {T}_{2}} u ( t - Δ {T}_{1} ) = \frac{Δ {I}_{2}}{Δ {T}_{2}} R ( t - Δ {T}_{1} ) \qquad ( 13 )$$

$${F}_{4} ( t ) = t \frac{Δ {I}_{2}}{Δ {T}_{2}} R ( t - ( Δ {T}_{1} + Δ {T}_{2} ) ) . \qquad ( 14 )$$

The Laplace transformation of equation 10 may yield the frequency domain expression for switch drain-to-source current during turn-off with a two slope transition according to the following:

$${I}_{{DS}_{2}} ( s ) = Δ {I}_{1} δ ( s ) - \frac{Δ {I}_{1}}{Δ {T}_{1}} \frac{1}{{s}^{2}} + \frac{Δ {I}_{1}}{Δ {T}_{1}} \frac{1}{{s}^{2}} {e}^{( - s Δ T 1 )} - \frac{Δ {I}_{2}}{Δ {T}_{2}} \frac{1}{{s}^{2}} {e}^{( - s Δ T 1 )} + \frac{Δ {I}_{2}}{Δ {T}_{2}} \frac{1}{{s}^{2}} {e}^{- s ( Δ T 1 + Δ T 2 )} \qquad ( 15 )$$

From FIG. 7, it can be inferred that switch drain-to-source current I_{DS}_{₁}(s) during the turn-off with a one-slope transition has a finite magnitude as a function of frequency which can be utilized in conjunction with the frequency dependent impedances, including the input impedance Zᵢₙ or Z_{in alt}, to evaluate the V_{DS}_{₁} as follows:

$${V}_{{DS}_{1}} ( s ) = {I}_{{DS}_{1}} ( s ) \times {Z}_{i n} ( s ) . \qquad ( 16 )$$

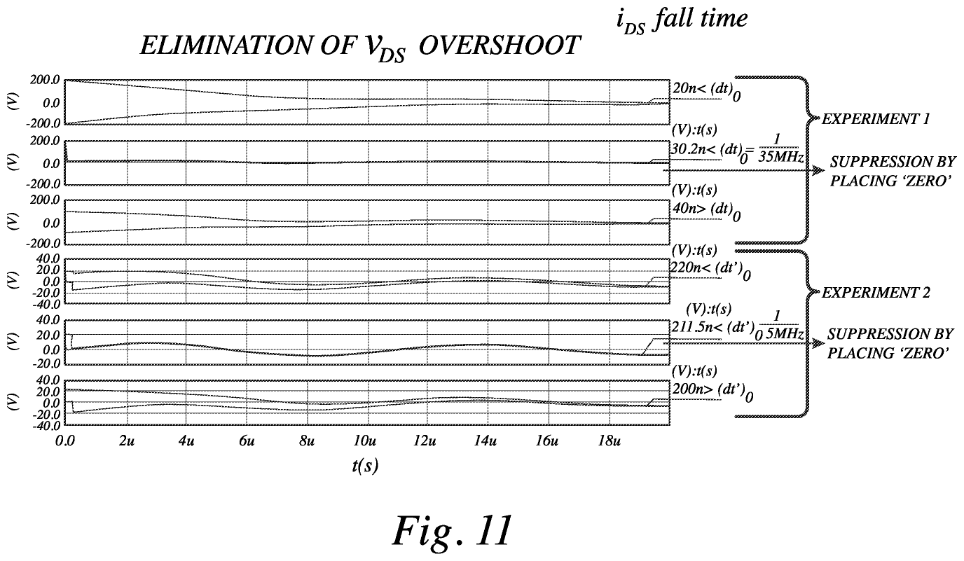

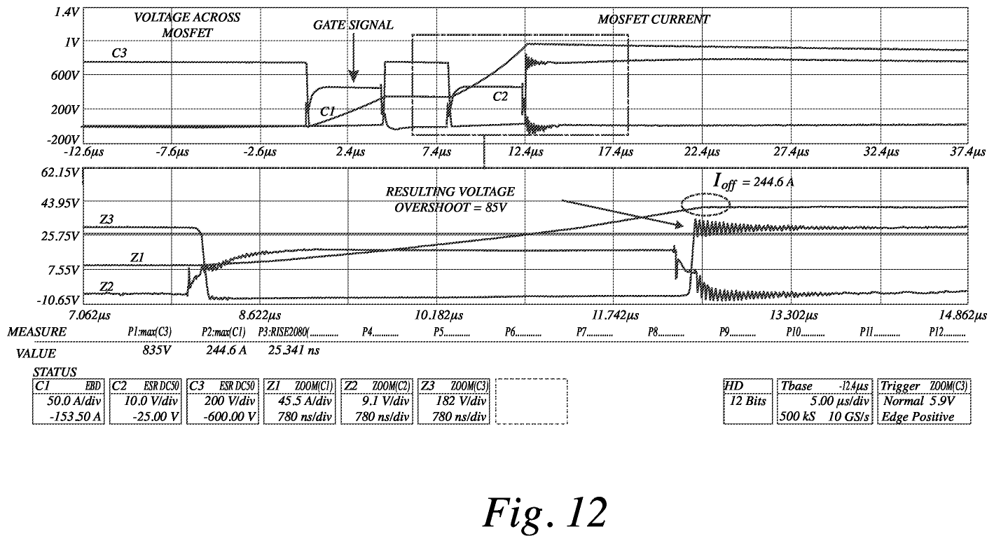

Turning to FIG. 10, the current spectra and the voltage spectra for the switch circuitry 116. It can be seen that the if the resonant frequency of the linear network is equal to or substantially proximal to zero, overshoot and ringing may be reduced, mitigated, or eliminated for fast switching (e.g., turning of 150A or more in 30.2 ns or less). Reduction or elimination of the V_{DS} overshoot can be seen in FIGS. 11 and 12 show experimental setups that utilize suppression according to one or more embodiments (e.g., placing zero) with respect to ringing and overshoot.

Placement of a turn off current zero can be implemented in a variety of ways within at least one of the switching circuitry 116, the controller 140, and the drive circuitry 142. The switch turn off time can be affected by at least one of changing the gate resistance and/or capacitance of the switching circuitry 116. For instance, no switching circuitry may be configured with a preset value of resistance, capacitance, or gain of an operational amplifier to control a turn off time.

Additionally or alternatively, the switch turn off time can be affected by controlling the turn off signal provided to the switching circuitry 116. For instance, The controller 140 and/or the Dr. circuitry 142 may actively switch values of gate resistors to control a turn off time of the switching circuitry 116. As another example, in real time, the controller 140 may utilize feedback from the sensor 144 to determine if voltage ringing is sensed, and measure the ringing frequency. The controller 140 may utilize the measured ringing frequency to adjust a corresponding turn off time to be the inverse of the measured ringing frequency, thereby mitigating ringing in the switching circuitry 116.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. Inverter circuitry comprising:
a half bridge including a first MOSFET switch and a second MOSFET switch, wherein the first MOSFET switch's drain is to be coupled to a high voltage port of a DC power source, the first MOSFET switch's source is coupled to the second MOSFET switch's drain, and the second MOSFET switch's source is to be coupled to a low voltage port of the DC power source;
wherein the second MOSFET switch is associated with a switching-transition network including a frequency-dependent input impedance zᵢₙ(f), the input impedance including a maximum value zₘₐₓ(f₀) at a resonant frequency f₀, the switching transition network corresponding to a switching transition occurring over duration ΔT;
wherein the second MOSFET switch's drain-source current I_{Ds}(s=j2πf) is frequency dependent and has a value of zero at the inverse of the switching-transition duration,
$${I}_{D S} ( \frac{1}{Δ T} ) = 0 ;$$
and
wherein the switching-transition duration is configured as the inverse of the input impedance's resonant frequency,
$$Δ T = \frac{1}{{f}_{0}} ,$$
to reduce overshot and/or parasitic ringing of the second MOSFET switch's drain-source voltage
$${{V}_{D S} ( s ) = ( {I}_{D S} ( s ) {z}_{i n} ( s ) ) \vert}_{{f}_{0} = \frac{1}{Δ T}} .$$

2. The inverter circuitry of claim 1 wherein active components of the inverter circuitry and passive components of the inverter circuitry are preconfigured to cause the switching-transition duration to match the inverse of the resonant frequency,
$$Δ T = \frac{1}{{f}_{0}} .$$

3. The inverter circuitry of claim 1 comprising:
a sensor circuit arranged and configured to:
sense ringing of the second MOSFET switch's drain-source voltage V_{DS}(t); and
determine a ringing frequency f₀ of the sensed drain-source voltage's ringing; and
a driver circuit configured to:
reset the second MOSFET switch's switching-transition duration to the determined inverse of the ringing frequency,
$$Δ T = \frac{1}{{f}_{0}} ;$$
and
drive the second MOSFET switch in accordance with the reset switching-transition duration.

4. The inverter circuitry of claim 1 wherein the switching transition is a turn-off switching transition of the drain-source current I_{DS}(s) from a specified value ΔI to zero over the duration ΔT.

5. The inverter circuitry of claim 1 wherein the first MOSFET switch and the second MOSFET switch each is a SiC MOSFET.

6. A wireless power transfer system for wirelessly providing AC power to an electric vehicle or a plug-in electric vehicle, the system comprising:
a DC power source; and
an instance of the inverter circuitry of claim 1.

7. An inverter operable to generate AC power, said inverter comprising:
an input operable to receive input power;
switching circuitry operably coupled to the input the switching circuitry, the switching circuitry operable to generate the AC power based on the input power, the switching circuitry operable to turn on and turn off to generate the AC power, the switching circuitry including a parasitic resonance in response to the turn off of the switching circuitry, the switching circuitry configured to turn off according to a turn off time that has a frequency response with a zero substantially corresponding to a parasitic resonant frequency f₀ of the parasitic resonance of the switching circuitry; and
an output operable to supply the AC power generated by the switching circuitry.

8. The inverter of claim 7 wherein the switching circuitry includes:
a first switch including a first switch upper node, a first switch lower node, and a first switch control node operable to control current flow between the first switch upper node and the first switch lower node;
a second switch including a second switch upper node, a second switch lower node, and a second switch control node operable to control current flow between the second switch upper node and the second switch lower node; and
wherein the turn off of the switching circuitry corresponds to controlling the second switch control node to substantially turn off the current flow between the second switch upper node and the second switch lower node, wherein an impedance of the second switch is associated with a frequency response during the turn off that defines the parasitic resonance of the switching circuitry over the turn off time.

9. The inverter of claim 8 wherein:
the first switch is a first MOSFET;
the first switch lower node is a first switch source;
the first switch upper node is a first switch drain;
the second switch is a second MOSFET;
the second switch lower node is a second switch source; and
the second switch upper node is a second switch drain.

10. The inverter of claim 8 wherein:
the first switch upper node is coupled to a high voltage port of the input;
the second switch lower node is coupled to a low voltage port of the input;
the first switch lower node is operably coupled to the second switch upper node; and
the first switch lower node and the second switch upper node are operably coupled to the output.

11. The inverter of claim 9 wherein the second switch is associated with a switching-transition network including the impedance, wherein the impedance of the switching-transition network is a frequency-dependent input impedance zᵢₙ(f), wherein the impedance includes a maximum value zₘₐₓ(f₀) at the parasitic resonant frequency f₀, the switching-transition network corresponding to a switching transition occurring over duration ΔT defined by the turn off time.

12. The inverter of claim 11 wherein the current between second switch upper node and the second switch lower node is frequency dependent according to the frequency response and the zero of the frequency response is at an inverse of duration ΔT, and
wherein the duration ΔT is configured as the inverse of the parasitic resonant frequency,
$$Δ T = \frac{1}{{f}_{0}} ,$$
to reduce overshoot and/or parasitic ringing of a voltage across the second switch upper f₀ node and the second switch lower node.

13. The inverter of claim 11 wherein the switching transition is a turn-off switching transition of the current between the second switch upper node and the second switch lower node from a specified value to zero over the duration ΔT.

14. The inverter of claim 7 wherein active components of the inverter and passive components of the inverter are preconfigured to cause the turn off time to match an inverse of the parasitic resonant frequency 1/f₀.

15. The inverter of claim 7 comprising:
a sensor circuit configured to:
sense ringing of a voltage across the second switch, and
determine a ringing frequency of the sensed ringing as the parasitic resonant frequency; and
a driver circuit configured to:
adjust the turn off duration to an inverse of the ringing frequency, and
drive the second switch in accordance with the adjusted turn off duration.

16. A wireless power supply for wireless transmitting AC power to a remote device, the wireless power supply comprising:
the inverter according to claim 7; and
a transmitter operably coupled to the output of the inverter, the transmitter operable to provide wireless power to the remote device based on AC power received from the output of the inverter.

17. The wireless power supply of claim 16 comprising a driver circuit operable to direct operation of the inverter circuit.

18. The wireless power supply of claim 17 wherein the driver circuit is configured to adjust the turn off time to reduce ringing at the parasitic resonant frequency.

19. The wireless power supply of claim 17 comprising sensor circuitry operable to detect a change in the parasitic resonant frequency f₀.

20. The inverter of claim 8 wherein the first switch and the second switch each is a SiC MOSFET.
